(19) United States
(12) Patent Application Publication
(10) Pub. No.: US 2026/0067802 A1
(43) Pub. Date: Mar. 5, 2026

(54) SYSTEMS, METHODS, AND DEVICES FOR SCHEDULING-BASED ENHANCED POWER PERFORMANCE IN WIRELESS DEVICES

(71) Applicant: Cypress Semiconductor Corporation, San Jose, CA (US)

(72) Inventors: Vivek Ramesh Vellore, San Jose, CA (US); Vikram Kumar Ramanna, San Jose, CA (US); Rakesh Taori, McKinney, TX (US); Bragadeesh Viswanathan, Milpitas, CA (US)

(73) Assignee: Cypress Semiconductor Corporation, San Jose, CA (US)

(21) Appl. No.: 18/824,747

(22) Filed: Sep. 4, 2024

(51) Int. Cl. H04W 52/02

(52) U.S. Cl. CPC H04W 52/0216

(57) ABSTRACT

Systems, methods, and devices enhance power performance of wireless devices. Methods include beginning a service period between wireless devices, the service period being configured in accordance with a wireless communications protocol, and determining, using one or more processing elements, whether or not there has been activity during a designated period of time within the service period. Methods further include determining, using the one or more processing elements, whether or not the service period should be terminated prior to a scheduled end of the service period, the determining being based, at least in part, on the activity.

### TECHNICAL FIELD

This disclosure relates to wireless devices, and more specifically, to enhancement of scheduling in such wireless devices.

### BACKGROUND

Wireless devices may include transceivers configured to generate and receive wireless signals in accordance with one or more wireless communications protocols. For example, such wireless devices may establish wireless connections using a wireless communications protocol, such as a Wi-Fi protocol. Such wireless connections may implemented in accordance with negotiated schedules used to manage periods of activity. Conventional wireless devices remain limited because they are limited in their ability to efficiently manage such periods of activity.

### BRIEF DESCRIPTION OF THE DRAWINGS

FIG. 1 illustrates an example of a system for wireless scheduling, configured in accordance with some embodiments.

FIG. 2 illustrates an example of a device for wireless scheduling, configured in accordance with some embodiments.

FIG. 3 illustrates an example of a method for wireless scheduling, performed in accordance with some embodiments.

FIG. 4 illustrates another example of a method for wireless scheduling, performed in accordance with some embodiments.

FIG. 5 illustrates yet another example of a method for wireless scheduling, performed in accordance with some embodiments.

FIG. 6 illustrates a diagram of an example of scheduling-based power performance enhancement, configured in accordance with some embodiments.

FIG. 7 illustrates a diagram of another example of scheduling-based power performance enhancement, performed in accordance with some embodiments.

FIG. 8 illustrates a diagram of an additional example of scheduling-based power performance enhancement, performed in accordance with some embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as not to unnecessarily obscure the described concepts. While some concepts will be described in conjunction with the specific examples, it will be understood that these examples are not intended to be limiting.

Wireless devices may communicate with each other via one or more wireless connections. Such wireless connections may be implemented in accordance with one or more wireless communications protocols, such as a Wi-Fi protocol. In various embodiments, during connection establishment, a wireless schedule may be negotiated between the wireless devices to coordinate and schedule activity on the wireless connection. Such negotiation may include the wireless devices requesting and agreeing upon designated periods of activity.

In one example, the wireless devices may include an access point (AP) and a station (STA). In this example, the access point may be in communication with multiple stations and may use the scheduling of active periods to manage communication with different stations. Such active periods may include service periods implemented in accordance with a Wi-Fi protocol. Accordingly, during negotiation, a station may request a service period of 1 ms, and an access point may reply with a response of 8 ms based on what is possible for the access point, and the station may determine whether or not to accept. In this example, the agreed upon duration of the service period may be longer than that requested by the station, and may thus result in inefficient usage of the resources of the station due to excess power consumption caused by an unnecessarily long period of activity defined by the service period.

Embodiments disclosed herein provide wireless scheduling techniques that enable wireless devices to enter an inactive mode early in response to a dynamic determination made based on activity on a wireless connection. More specifically, and as will be discussed in greater detail below, a station may monitor activity on the wireless connection and determine that a service period may be terminated early and prior to the previously agreed-upon time, and may enter an inactive mode. Returning to a previous example, if the service period was negotiated to be 8 ms, the station may determine that the entire 8 ms is not needed, and may terminate the service period early after, for example, 256 μs. In this way, the station may be configured to dynamically modify the implementation of previously agreed-upon service periods in a manner that improves power efficiency and is also transparent to the access point.

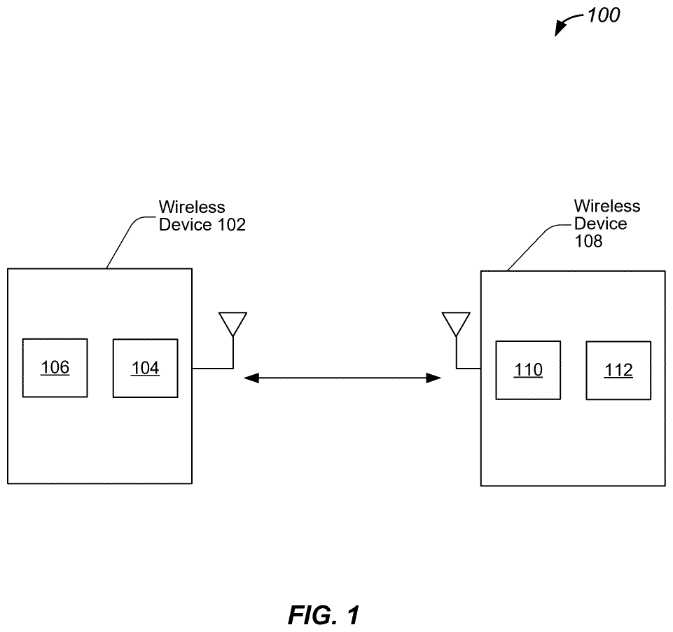

FIG. 1 illustrates an example of a system for wireless scheduling, configured in accordance with some embodiments. Accordingly, a system, such as system 100, may include wireless devices that are used for wireless communications, and are configured to establish wireless connections used for such wireless communications. As will be discussed in greater detail below, wireless devices included in system 100 may be configured to dynamically determine if a service period should be terminated early, thus enabling power savings by reducing a duration of an active mode. Moreover, such dynamic determinations may be made by a station, thus allowing implementation of such early service period termination by a station in addition to capabilities of an associated access point.

In some embodiments, system 100 includes wireless device 102 which is configured to transmit and receive wireless signals in accordance with one or more communications protocols. For example, wireless device 102 may include one or more transceivers, such as transceiver 104, which is configured to transmit and receive signals in accordance with a wireless communications protocol, such as a Wi-Fi protocol. In various embodiments, wireless device 102 additionally includes a processing device, such as processing device 106, which is configured to implement various hardware and logic associated with transceiver 104, and its associated wireless communications protocol. For example, processing device 106 may be configured to implement a medium access control (MAC) layer that is configured to control hardware associated with a wireless transmission medium, such as that associated with a Wi-Fi transmission medium.

In various embodiments, wireless device 102 is within communications range of one or more devices or entities. In one example, wireless device 102 is within range of wireless device 108, which may be another wireless device. Accordingly, wireless device 108 may also include a transceiver and associated processing logic configured to facilitate wireless communications in accordance with a wireless communications protocol, such as a Wi-Fi protocol. For example, wireless device 108 may include processing device 110 and transceiver 112.

In various embodiments, wireless device 102 may be configured to establish a wireless connection with device 108, and transmit and receive data packets to and from device 108. In one example, wireless device 102 may be configured as a central device, such as an access point (AP), and wireless device 108 may be configured as a peripheral device, such as a station (STA). In various embodiments, wireless device 102 and wireless device 108 may initially negotiate a schedule of activity in which wireless device 102 and wireless device 108 agree on a schedule identifying designated durations of time during which wireless device 108 will set the wireless connection to an inactive mode, also referred to as a sleep mode, and during which wireless device 108 will set the wireless connection to an active mode, also referred to as an active mode. In various embodiments, such active periods may be scheduled service periods during which wireless device 102 and wireless device 108 may exchange data.

As will be discussed in greater detail below, wireless device 108 may be configured to identify previous activity on the wireless connection, and determine if the service period should be terminated early, and if a sleep mode should be entered early thus providing additional power savings by reducing an amount of time wireless device 108 is active. As discussed above, wireless device 108 may be a station, and thus may make such a determination station-side, and in addition to power-saving capabilities of the access point.

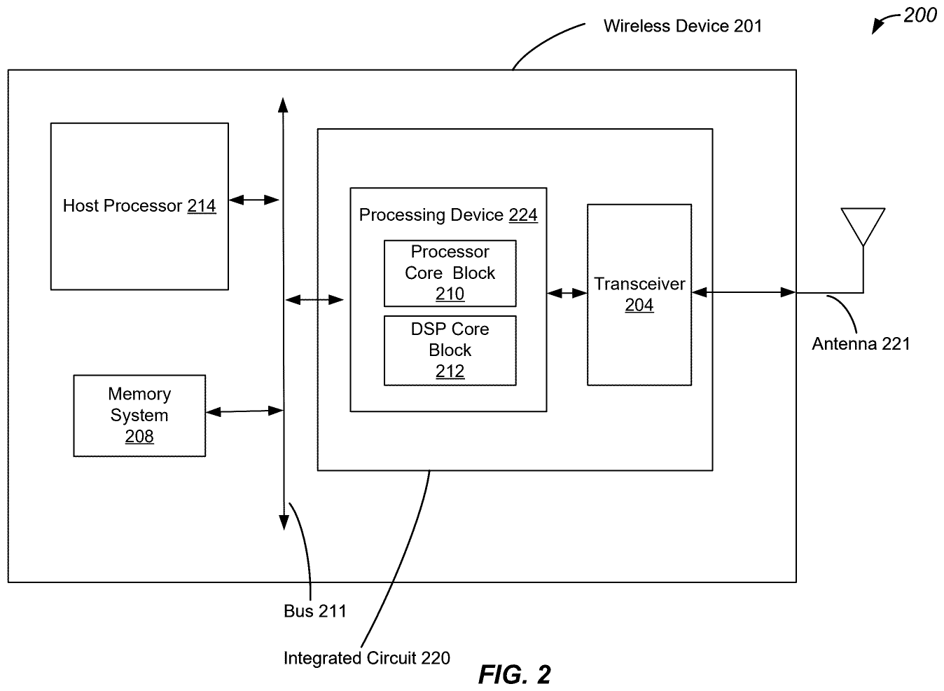

FIG. 2 illustrates an example of a device for wireless scheduling, configured in accordance with some embodiments. More specifically, FIG. 2 illustrates an example of a system, such as system 200, that may include wireless device 201. It will be appreciated that wireless device 201 may be one of any of the wireless devices discussed above with reference to FIG. 1, such as wireless device 102 and wireless device 108.

In various embodiments, wireless device 201 includes one or more transceivers, such as transceiver 204. In one example, wireless device 201 includes transceiver 204 which is configured to transmit and receive signals using a communications medium that may be accessed and used via antenna 221. As noted above, transceiver 204 may be a Wi-Fi transceiver. Accordingly, transceiver 204 may be compatible with a wireless communications protocol, such as a Wi-Fi protocol. In various embodiments, transceiver 204 includes a modulator and demodulator as well as one or more buffers and filters, that are configured to generate and receive signals via antenna 221. Accordingly, transceiver 204 may include chains of components configured to perform such operations, such as a transmit chain and a receive chain.

In various embodiments, system 200 further includes one or more processing devices, such as processing device 224 which may include logic implemented using one or more processor cores. Accordingly, processing device 224 is configured to implement logic for wireless scheduling. For example, processing device 224 may be configured to monitor and identify activity on a wireless channel of a wireless connection, and may be further configured to determine whether or not a service period should be terminated early based on a pattern of previous activity. Accordingly, processing device 224 includes processing elements, that may be implemented in firmware, configured to perform wireless scheduling operations in which determinations are made regarding termination of a service period. For example, a scheduler implemented within processing device 224 may be configured to perform such wireless scheduling operations and determinations.

Processing device 224 includes one or more components configured to implement a media access control (MAC) layer that is configured to control hardware associated with a wireless transmission medium, such as that associated with a Wi-Fi transmission medium. In one example, processing device 224 may be configured to implement a driver, such as a Wi-Fi driver. Accordingly, processing device 224 may include components associated with transceiver 204, such as MAC layers, packet traffic arbiters, and a scheduler. In various embodiments, processing device 224 includes processing blocks, such as processor core block 210 and DSP core block 212, to implement these features.

System 200 further includes antenna 221 which is configured to transmit and receive wireless signals. In one example, antenna 221 may be coupled to transceiver 204, and may be used to transmit and receive signals from transceiver 204. While FIG. 2 illustrates one antenna, it will be appreciated that wireless device 201 may include multiple antennas.

System 200 includes memory system 208 which is configured to store one or more data values associated with wireless scheduling operations discussed in greater detail below. Accordingly, memory system 208 includes storage device, which may be a non-volatile random-access memory (NVRAM) configured to store such data values, and may also include a cache that is configured to provide a local cache. In various embodiments, system 200 further includes host processor 214 which is configured to implement processing operations implemented by system 200.

It will be appreciated that one or more of the above-described components may be implemented on a single integrated circuit, or on different integrated circuits. For example, transceiver 204 and processing device 224 may be implemented on the same integrated circuit, such as integrated circuit 220. In another example transceiver 204 and processing device 224 may each be implemented on their own integrated circuit, and thus may be disposed separately as a multi-die module or on a common substrate such as a printed circuit board (PCB). It will also be appreciated that components of system 200 may be implemented in a variety of contexts, such as the context of a smart home environment, an automotive environment, or a wireless environment including Internet of Things (IoT) devices.

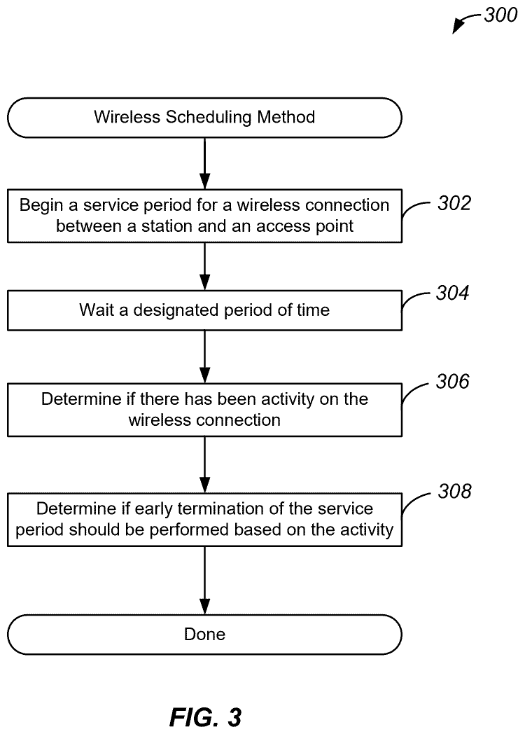

FIG. 3 illustrates an example of a method for wireless scheduling, performed in accordance with some embodiments. As similarly discussed above, wireless devices disclosed herein may be configured to perform a method, such as method 300, to determine they may transition to an inactive mode to improve power performance and reduce power consumption. More specifically, a wireless device, such as a station, may determine that a service period may be terminated early, and may switch to an inactive mode prior to a previously scheduled termination of the service period thus reducing a duration of time for which the station is active and consuming more power.

Method 300 may perform operation 302 during which a service period may begin for a wireless connection between wireless devices. As similarly discussed above, the wireless devices may have negotiated a schedule during wireless connection establishment, and the schedule may determine when service periods are implemented between the wireless devices. Accordingly, during operation 302, a service period may begin and both wireless devices may be in an active mode.

Method 300 may perform operation 304 during which one or more of the wireless devices may wait for a designated period of time. Accordingly, a designated period of time may elapse in which the wireless connection is available for data exchange. Such a designated period of time may be defined by an entity, such as a manufacturer or a user. In some embodiments, the designated period of time is defined based on a wireless communications standard, such as any suitable Wi-Fi standard.

Method 300 may perform operation 306 during which it may be determined if there has been activity on the wireless connection. More specifically, a wireless device may determine if any data has been transmitted or received during the designated period of time, and may use such information to infer whether or not there is activity on the wireless connection.

Method 300 may perform operation 308 during which it may be determined if early termination of the service period should be performed. In various embodiments, such a determination is made based, at least in part, on the identified activity. As will be discussed in greater detail below, a wireless device may be configured to determine if conditions for early termination have been met, and if not, further determine an additional designated period of time to wait before checking again. As will be discussed in greater detail below, the additional designated period of time may be modified dynamically based on previous activity to further reduce power consumption.

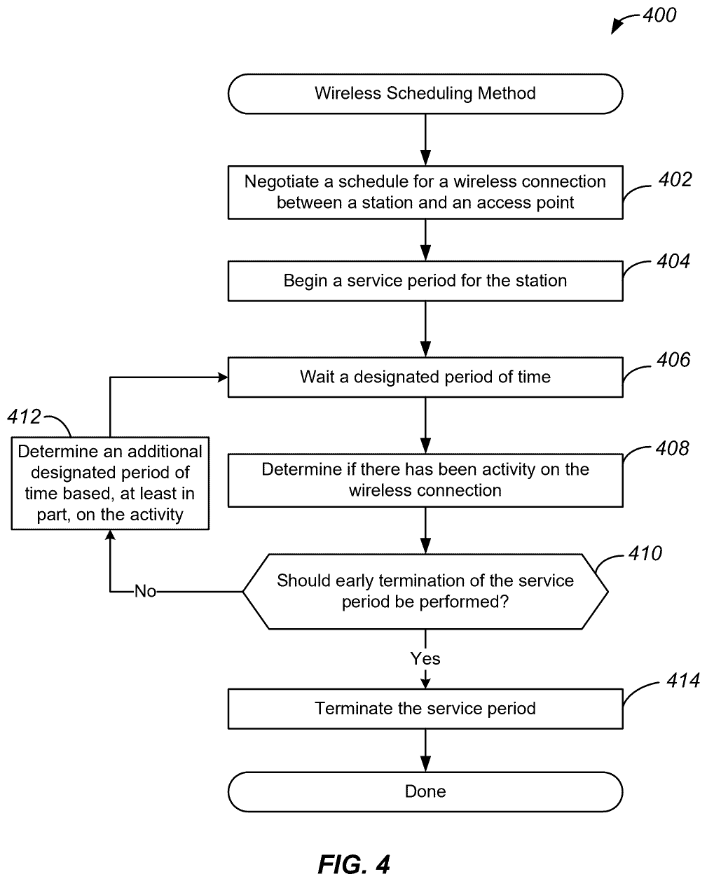

FIG. 4 illustrates another example of a method for wireless scheduling, performed in accordance with some embodiments. As similarly discussed above, wireless devices disclosed herein may be configured to perform a method, such as method 400, to determine they may transition to an inactive mode to improve power performance and reduce power consumption. More specifically, a station may be configured to determine that a service period may be terminated early, and may switch to an inactive mode prior to a previously scheduled termination of the service period. Moreover, a frequency at which early termination determinations are made may be adjusted based on previous activity to further improve power performance and reduce power consumption.

Method 400 may perform operation 402 during which a schedule may be negotiated between an access point and a station. Accordingly, as similarly discussed above, as part of connection establishment, the access point and the station may negotiate a schedule of active periods and inactive periods in which the station is asleep during the inactive period, and is awake during the active period and available for data transfer. As also discussed above, the active periods may include service periods as defined by a wireless communications standard, such as any suitable Wi-Fi standard.

Method 400 may perform operation 404 during which a service period may begin for the station. As similarly discussed above, the service period may have been previously negotiated during wireless connection establishment. Accordingly, at a designated time, both the access point and station may be in an active mode, and may be available for data transfer over the wireless connection.

Method 400 may perform operation 406 during which the station may wait for a designated period of time. As similarly discussed above, a designated period of time may elapse in which the wireless connection is available for data exchange. For example, one or more data frames may be transmitted by or received by the station. Such a designated period of time may be defined by an entity, such as a manufacturer or a user. In some embodiments, the designated period of time is defined based on a wireless communications standard, such as any suitable Wi-Fi standard.

Method 400 may perform operation 408 during which it may be determined if there has been activity on the wireless connection. More specifically, the station may determine if any data has been transmitted or received during the designated period of time. For example, the station may determine if any data frames have been received. The reception of a data frame may be identified as an activity event.

Method 400 may perform operation 410 during which it may be determined if early termination of the service period should be performed. In various embodiments, such a determination is made based, at least in part, on the identified activity. More specifically, if no activity has been identified and no data has been exchanged during the designated period of time, it may be determined that there is no activity on the wireless connection, and method 400 may proceed to operation 414 discussed in greater detail below in which the service period is terminated early by the station. In various embodiments, if activity has been identified and data has been exchanged during the designated period of time, it may be determined that early termination should not be performed, and method 400 may proceed to operation 412.

Accordingly, method 400 may perform operation 412 during which an additional designated period of time may be determined. In various embodiments, the additional designated period of time may be an additional duration of time for which the station should wait before checking again to see if early service period termination should be applied. The additional designated period of time may be dynamically determined based on the identified activity as well as previous results of service period termination determination.

In one example, the station may be configured to implement a binary exponential backoff algorithm in which consecutive identifications of activity on the wireless connection result in the selection of longer durations of time. In this way, the station may be configured to set a time at which the early service period termination determination is revisited, and the setting of the time may be dynamically determined based on previous activity such that an increased frequency of activity events results in a decreased frequency of service period termination determinations. Moreover, an initial duration of time may be a default value, such as a minimum time slot value as may be determined by a wireless communications standard, or a random number of time slots. The number of time slots may then be increased based on the occurrence of successive activity event detections.

Returning to operation 410, if it is determined that early termination should be performed, method 400 may proceed to operation 414 during which the service period may be terminated by the station. Accordingly, the station may transmit a message to the access point indicating it is switching to an inactive mode, and the station may then switch to the inactive mode. As discussed above, such termination of the service period may occur prior to the previously agreed upon end of the service period, thus reducing the active time of the station and reducing power consumption of the station.

It will be appreciated that multiple iterations of operations, such as operations 406, 408, 410, and 412 may be performed within a single service period. For example, a service period may have a duration defined in milliseconds, and time slots and periods of time may be defined in microseconds. Accordingly, multiple determinations of whether or not activity has occurred, and multiple dynamic determinations of additional periods of time for which to wait may occur within the context of a single service period thus allowing such dynamic determination techniques to converge on an appropriate time at which the station can terminate the service period early.

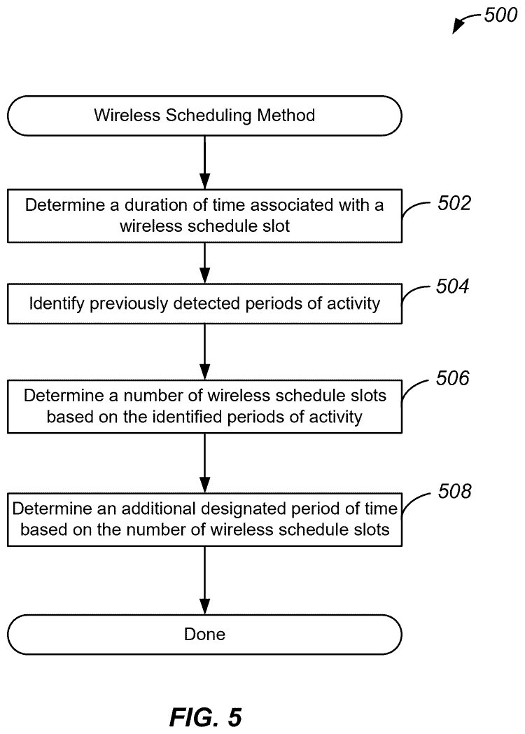

FIG. 5 illustrates yet another example of a method for wireless scheduling, performed in accordance with some embodiments. As similarly discussed above, wireless devices disclosed herein may be configured to determine they may transition to an inactive mode to improve power performance and reduce power consumption. In various embodiments, a method, such as method 500, may be performed to dynamically manage the implementation of early termination determinations.

Method 500 may perform operation 502 a duration of time may be determined. As similarly discussed above, in response to identifying activity on a wireless connection, an additional designated period of time may be determined. In various embodiments, the additional designated period of time may have a duration that is initially set to a default value that may be one or some random number of wireless schedule slots. In various embodiments, a wireless schedule slot may be a temporal unit within a wireless schedule that represents a unit of time. Such units of time may be defined by a wireless communications standard and may be used to facilitate the representation and negotiation of wireless schedules. Accordingly, a wireless schedule slot may have a defined temporal duration, and the additional designated period of time may be defined by a number of wireless schedule slots.

Method 500 may perform operation 504 during which previously detected activity events may be identified. Accordingly, it may be determined if activity events have been detected, as discussed above with reference to FIG. 4. Moreover, it may be determined if previous positive determinations have also been made. Accordingly, historical data for the wireless connection may be retrieved to identify the occurrence of successive activity event detections if such successive activity events have occurred.

Method 500 may perform operation 506 during which a number of time slots may be determined based on the identified activity events. As similarly discussed above, a number of previous activity events may be used to dynamically determine a duration of time by which the next early service period termination determination is delayed. For example, a number of time slots may be given by equation 1 shown below:

$$T = 2 \hat{} c \qquad ( 1 )$$

In equation 1, T represents a number of time slots, and c represents a number of activity events that have been identified. Accordingly, the delay of the early service period termination determination may increase exponentially as the number of activity events increases. In one example, T may be set to a random number between 1 and (2\hat{ }c). In various embodiments, such randomization may be configured to provide a variance that facilitates determination of a number of time slots that provides a balance between power savings from an inactive mode and providing sufficient opportunity for activity events.

Method 500 may perform operation 508 during which an additional designated period of time may be determined based on the number of wireless schedule slots. As similarly discussed above, each wireless schedule slot may have a defined duration of time. Thus, the number of wireless schedule slots and the temporal duration of each time slot may be used to compute a total additional designated period of time. In some embodiments, the number of wireless schedule slots is sufficient for the station, and operation 508 is not performed. Accordingly, operation 508 may be performed optionally to provide an additional representation of the additional designated period of time.

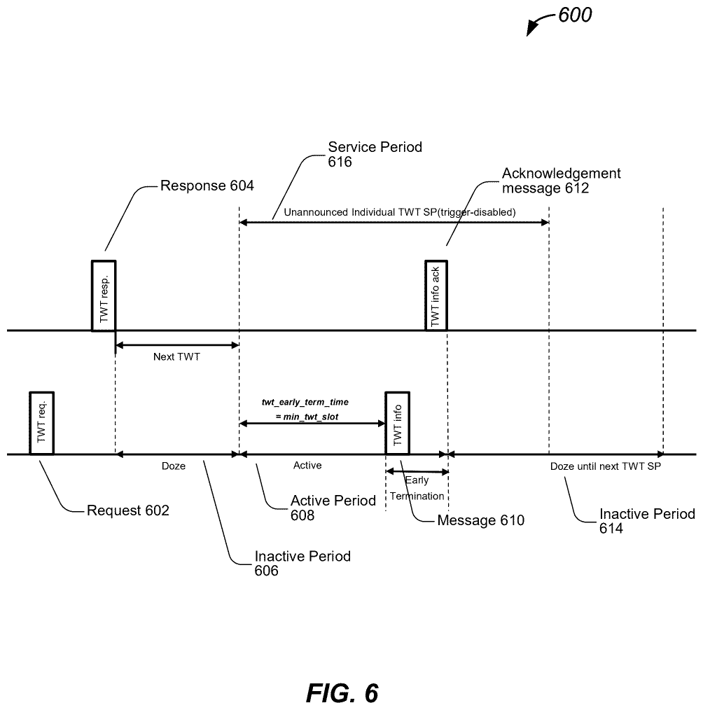

FIG. 6 illustrates a diagram of an example of scheduling-based power performance enhancement, configured in accordance with some embodiments. As shown in diagram 600, a wireless schedule may initially be negotiated, and a station may send request 602, and an access point may send response 604. The station may initially be in an inactive mode during inactive period 606 and may transition to an active mode in active period 608 when the scheduled service period for the station begins.

As shown in diagram 600, no activity events have occurred during active period 608. Accordingly, the station may wait a designated period of time, make the determination that no activity events have occurred, and may then determine that early termination of the service period should be performed. Accordingly, in response to making such a determination, the station may send message 610 to the access point to indicate that it is switching to an inactive mode for inactive period 614, and the access point may send acknowledgment message 612 in response. As shown in diagram 600, the switch to the inactive mode occurs prior to the previously scheduled termination of service period 616, thus allowing the station to terminate the service period early.

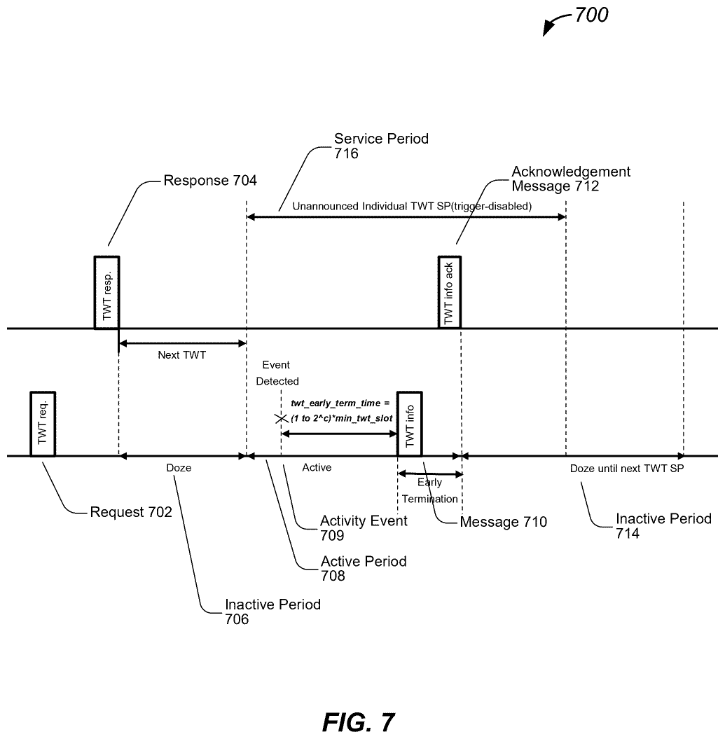

FIG. 7 illustrates a diagram of another example of scheduling-based power performance enhancement, performed in accordance with some embodiments. As shown in diagram 700, a wireless schedule may initially be negotiated, and a station may send request 702, and an access point may send response 704. The station may initially be in an inactive mode during inactive period 706 and may transition to an active mode in active period 708 when the scheduled service period for the station begins.

As shown in diagram 700, activity event 709 may occur during active period 708. Accordingly, the station may wait a designated period of time, make the determination that an activity event has occurred, and may then determine an additional period of time to wait before checking for activity again. As discussed above, the additional period of time may be a number of wireless schedule slots set to 2\hat{ }c, or some random number between (and inclusive of) 1 and 2\hat{ }c, where c is a number of activity events previously detected within service period 716.

In the example, shown in diagram 700, activity event 709 has been detected, the station has waited an additional amount of time defined by a number of wireless schedule slots between (and inclusive of) 1 and 2\hat{ }c, determined that no additional activity has occurred, and then initiated early service period termination after determining that no additional activity events have occurred. As similarly discussed above, the station may send message 710 to the access point to indicate that it is switching to an inactive mode for inactive period 714, and the access point may send acknowledgment message 712 in response. As shown in diagram 700, the switch to the inactive mode occurs prior to the previously scheduled termination of service period 716 despite waiting the additional amount of time, thus allowing the station to terminate the service period early.

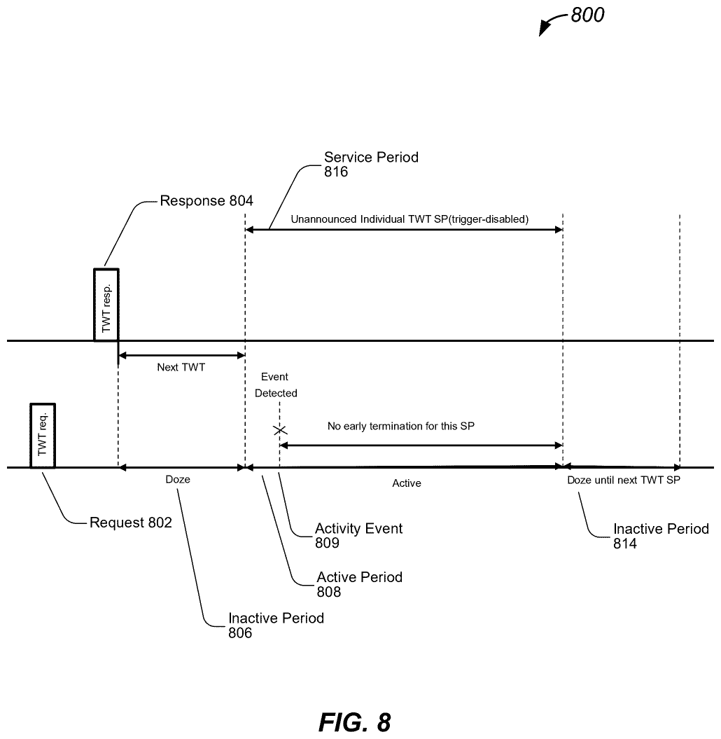

FIG. 8 illustrates a diagram of an additional example of scheduling-based power performance enhancement, performed in accordance with some embodiments. As shown in diagram 800, a wireless schedule may initially be negotiated, and a station may send request 802, and an access point may send response 804. The station may initially be in an inactive mode during inactive period 806 and may transition to an active mode in active period 808 when the scheduled service period for the station begins.

As shown in diagram 800, activity event 809 may occur during active period 808. Accordingly, the station may wait a designated period of time, make the determination that an activity event has occurred, and may then determine an additional period of time to wait before checking for activity again. As discussed above, the additional period of time may be a number of wireless schedule slots set to 2\hat{ }c, or some random number between (and inclusive of) 1 and 2\hat{ }c, where c is a number of activity events previously detected within service period 716. However, in the example shown in diagram 800, the determined additional period of time may exceed the remaining time in service period 816. Thus, according to some embodiments, the station is further configured to determine if the additional period of time exceeds the remaining service period, and is further configured to cancel early service period termination if such a determination is made.

Although the foregoing concepts have been described in some detail for purposes of clarity of understanding, it will be apparent that certain changes and modifications may be practiced within the scope of the appended claims. It should be noted that there are many alternative ways of implementing the processes, systems, and devices. Accordingly, the present examples are to be considered as illustrative and not restrictive.

What is claimed is:

1. A method comprising:
beginning a service period between wireless devices, the service period being configured in accordance with a wireless communications protocol;
determining, using one or more processing elements, whether or not there has been activity during a designated period of time within the service period; and
determining, using the one or more processing elements, whether or not the service period should be terminated prior to a scheduled end of the service period, the determining being based, at least in part, on the activity.

2. The method of claim 1, wherein a termination of the service period comprises:
switching a wireless device from an active mode to an inactive mode.

3. The method of claim 1, wherein the determining whether or not the service period should be terminated further comprises:
monitoring activity on a wireless connection during the service period;
determining no activity has occurred during the designated period of time; and
determining that the service period can be terminated prior to the scheduled end of the service period.

4. The method of claim 1, wherein the determining whether or not the service period should be terminated further comprises:
determining activity has occurred during the designated period of time;
determining an additional amount of time based on the activity; and
waiting the additional amount of time before performing an additional determination of whether or not the service period should be terminated.

5. The method of claim 4, wherein the additional amount of time is determined based on a number of identified activity events.

6. The method of claim 5, wherein the additional amount of time is determined using a binary exponential backoff algorithm and the number of identified activity events.

7. The method of claim 1, wherein the wireless devices comprise an access point and a station, and wherein the wireless devices are Wi-Fi compatible devices.

8. The method of claim 7, wherein the determining whether or not the service period should be terminated is performed by the station.

9. The method of claim 8, wherein the service period is negotiated between the access point and the service period in accordance with a Wi-Fi protocol.

10. A system comprising:
a transceiver included in a station and configured to transmit and receive wireless signals from an access point compatible with a wireless communications protocol; and
a processing device included in the station and comprising one or more processing elements configured to:
begin a service period between wireless devices, the service period being configured in accordance with a wireless communications protocol;
determine whether or not there has been activity during a designated period of time within the service period; and
determine whether or not the service period should be terminated prior to a scheduled end of the service period, the determining being based, at least in part, on the activity.

11. The system of claim 10, wherein the one or more processing elements are further configured to:
switch the station from an active mode to an inactive mode.

12. The system of claim 10, wherein the one or more processing elements are further configured to:
monitor activity on a wireless connection during the service period;
determine no activity has occurred during the designated period of time; and
determine that the service period can be terminated prior to the scheduled end of the service period.

13. The system of claim 10 wherein the one or more processing elements are further configured to:
determine activity has occurred during the designated period of time;
determine an additional amount of time based on the activity; and
wait the additional amount of time before performing an additional determination of whether or not the service period should be terminated.

14. The system of claim 13, wherein the additional amount of time is determined based on a number of identified activity events.

15. The system of claim 14, wherein the additional amount of time is determined using a binary exponential backoff algorithm and the number of identified activity events.

16. A device comprising:
one or more processing elements configured to:
begin a service period between wireless devices, the service period being configured in accordance with a wireless communications protocol;
determine whether or not there has been activity during a designated period of time within the service period; and
determine whether or not the service period should be terminated prior to a scheduled end of the service period, the determining being based, at least in part, on the activity.

17. The device of claim 16, wherein the one or more processing elements are further configured to:
switch a wireless device from an active mode to an inactive mode.

18. The device of claim 16, wherein the one or more processing elements are further configured to:
monitor activity on a wireless connection during the service period;
determine no activity has occurred during the designated period of time; and
determine that the service period can be terminated prior to the scheduled end of the service period.

19. The device of claim 16, wherein the one or more processing elements are further configured to:
determine activity has occurred during the designated period of time;
determine an additional amount of time based on the activity; and
wait the additional amount of time before performing an additional determination of whether or not the service period should be terminated.

20. The device of claim 16, wherein the wireless devices comprise an access point and a station, and wherein the wireless devices are Wi-Fi compatible devices, and wherein the determining whether or not the service period should be terminated is performed by the station.
